(19) United States
(12) Patent Application Publication
(10) Pub. No.: US 2005/0062856 A1
(43) Pub. Date: Mar. 24, 2005

(54) Camera equipped with red-eye correction feature

(75) Inventor: Takafumi Matsushita, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/942,784

(22) Filed: Sep. 17, 2004

(30) Foreign Application Priority Data
Sep. 19, 2003 (JP) 2003-327521

(51) Int. Cl. H04N 5/228

(52) U.S. Cl. 348/222.1

(57) ABSTRACT

The camera is equipped with a red-eye correction feature. The camera has an imaging unit for acquiring digital image data of a subject, a first folder for storing original image data that has undergone no image processing or default image processing alone on the digital image data, an automatic red-eye correction unit for automatically detecting red-eye on a photographed subject image in the original image data and automatically modifying the thus detected red-eye to obtain corrected digital image data, a second folder for storing at least one of the corrected digital image data and red-eye correction information related to the original image data and used to perform the automatic red-eye correction, the second folder being separate from the first folder.

### BACKGROUND OF THE INVENTION

The present invention relates to a camera equipped with a red-eye correction feature, and in particular to a camera equipped with a red-eye correction feature designed to store processed image data after performing image processing including red-eye correction in the camera.

Conventionally, printing of an image photographed on a film such as a negative film and a reversal film on a photosensitive material (printing paper) is performed by way of so-called direct printing whereby an image on a film is projected on a photosensitive material for exposure.

In recent years, a digital photo printer has been commercially practical which performs various types of image processing or digital processing on a digital signal converted from an image obtained by photoelectrically reading the image recorded on a film or on the digital data of an image photographed with a digital camera to produce image data for recording, exposes a photosensitive material with recording light modulated in accordance with the image data, and outputs the exposed photosensitive material as a print.

In this way, image processing is digitally performed by way of signal processing. This corrects colors and densities quite preferably as well as obtains a high-quality image through image processing basically unavailable on a usual direct-exposure printer, such as gradation correction and sharpness processing (sharpness enhancement).

The most important factor which determines the picture quality of a photograph in an image containing that of a person such as a portrait is the finish of the person. Thus, the red-eye effect or a red appearance of the eye (pupil) on a photo print caused by flash photography considerably degrades the picture quality and presents a serious problem.

The red-eye effect often occurs when a person is photographed by using an electronic flash from the front especially in a dark place or in the nighttime. The red-eye-effect takes place in the following way: the electronic flashlight impinges on the eyes of a person with the pupils open from the front in a dark place, and the electronic flashlight is regularly reflected, which state appears in the image. The red-eye effect includes red-eye where the pupils of a person appear in red and gold-eye where the pupils of a person appear in gold. In the following description, red-eye refers to both cases.

In order to suppress the red-eye effect, a camera equipped with a preliminary electronic flash feature has been developed which preliminarily fires an electronic flash before photographing to reduce the opening of the pupils of a subject as a cause of red-eye, then performs electronic flash photography. However, preliminary firing of an electronic flash cannot always prevent red-eye depending on the personal difference between subject persons and difference between photographing conditions.

Various methods have been proposed which corrects a red-eye image by way of digital image processing to produce an image free from red-eye.

For example, a method for accurately extracting the face region of a subject person is known in which a candidate face region assumed to correspond to the face of a person in an image is extracted, the candidate region is divided into blocks, a characteristic amount is obtained by block and the characteristic amount against a matching pattern is checked to evaluate the accuracy of a face region (for example, refer to JP 2000-137788 A); another method for performing red-eye processing is also known in which the characteristic amount of an image is calculated based on a color value obtained from hue, saturation and lightness of each pixel, an image of the pupils of a subject person is extracted based on the characteristic amount obtained (for example, refer to JP 2000-076427 A)

While an image processor external to a camera receives an image photographed with a camera and performs red-eye correction in the foregoing example, a digital camera has also been developed to perform red-eye correction therein. For example, a digital camera equipped with a red-eye correction feature is known which captures an image of a scene, detects a face in the scene, checks the presence of red-eye in the image by way of a red-eye detection algorithm, and processes the image (for example, refer to JP 2001-309225 A).

However, the conventional camera with the red-eye correction feature stores only an image itself photographed with a CCD (imaging means) or an image which has undergone default image processing (so-called auto-setup) inside the camera. Such images are hereinafter referred to as original images. Red-eye correction in the camera only overwrites these original images and fails to support common image processing both inside and outside the camera.

### SUMMARY OF THE INVENTION

The invention has been accomplished in view of the aforementioned problems and has as an object to provide a camera equipped with a red-eye correction feature capable of storing photographed image data itself and/or data of a photographed image which has undergone only default image processing, that is, original image data, as well as image data which has undergone red-eye correction inside the camera and red-eye correction information for performing red-eye correction, thereby performing common image processing both inside and outside the camera.

In order to attain the object described above, the present invention provides a camera equipped with a red-eye correction feature, said camera comprising: imaging means for photographing a subject to acquire digital image data; a first folder for storing original image data which has undergone no image processing or default image processing alone on said digital image data; automatic red-eye correction means for performing an automatic red-eye correction on said original image data by detecting automatically red-eye on a photographed subject image in said original image data and modifying automatically the thus detected red-eye to obtain corrected digital image data which has undergone said automatic red-eye correction; and a second folder for storing at least one of said corrected digital image data and red-eye correction information related to said original image data and used to perform said automatic red-eye correction, said second folder being separate from said first folder.

It is preferable that the camera equipped with the red-eye correction feature further comprises: selection means for selecting whether said second folder stores said corrected digital image data and said red-eye correction information, or said red-eye correction information alone.

It is another preferable that said original image data is Exif image data, and said selection means selects whether said second folder stores said corrected digital image data and said red-eye correction information, or said red-eye correction information alone, and alternatively, whether said red-eye correction information including at least presence or absence of said red-eye correction is recorded in an Exif tag.

It is further preferable that said red-eye correction information includes at least one of presence or absence of said red-eye correction, a difference mask between said corrected digital image data and said original image data, and information used to create a red-eye-corrected image.

It is further preferable that said red-eye correction information includes at least one selected from the group consisting of information on presence or absence of red-eye detection, information on presence or absence of red-eye modification, information on presence or absence of said red-eye correction, information on a red-eye detection position, information on a red-eye detection area, red-eye position information, information on detected red-eye count, information on a detected face position, information on a detected face area, information on face position, red-eye correction mask information, and degree of red-eye modification.

According to the present invention, image data which has undergone automatic red-eye correction in a camera and/or red-eye correction information for performing the automatic red-eye correction in the same way inside and outside the camera are stored separately from original image data, so that even image abnormalities that occurred after the automatic red-eye correction can be dealt with to perform common image processing inside and outside the camera.

This application claims priority on Japanese patent application No. 2003-327521, the entire contents of which are hereby incorporated by reference.

### BRIEF DESCRIPTION OF THE DRAWINGS

FIG. 1 is a block diagram showing the schematic construction of a digital still camera as an embodiment of a camera equipped with a red-eye correction feature according to the invention;

FIG. 2A illustrates an example of folder structure in an image memory of the camera shown in FIG. 1;

FIG. 2B illustrates another example of folder structure in the-image memory of the camera shown in FIG. 1;

FIG. 2C illustrates still another example of folder structure in the image memory of the camera shown in FIG. 1;

FIG. 3 is a block diagram schematically showing an image output system including the camera shown in FIG. 1; and

FIG. 4 is a flowchart of the operation of this embodiment.

### DETAILED DESCRIPTION OF THE INVENTION

A camera equipped with a red-eye correction feature according to the invention is detailed below based on the best modes for implementing the invention shown in the attached drawings.

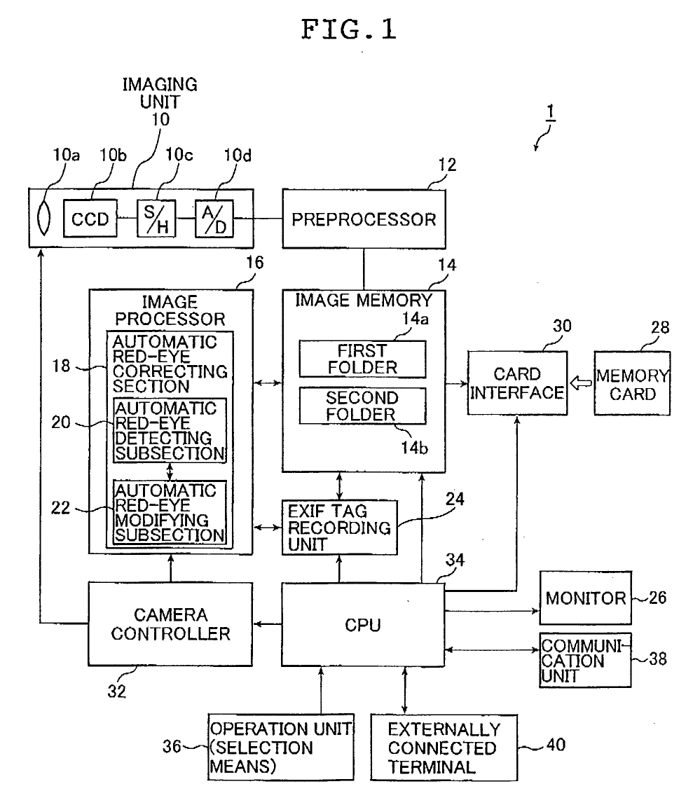

FIG. 1 is a block diagram showing the schematic construction of a digital still camera (hereinafter referred to simply as a camera) as an embodiment of a camera equipped with a red-eye correction feature according to the invention. As shown in FIG. 1, a camera 1 comprises an imaging unit 10 for photographing a subject to obtain digital image data, a preprocessor 12 for performing default image processing (so-called auto-setup), an image memory 14 for storing the digital image data of the subject obtained through photographing, and an image processor 16 including an automatic red-eye correcting section 18 for performing automatic red-eye correction on a red-eye containing image.

The imaging unit 10 comprises a photographing lens 10a, a CCD 10b as an image pickup device, a sample hold circuit (S/H) 10c, and an analog/digital (A/D) converter 10d.

The preprocessor 12 performs default image processing such as auto setup on data of a photographed image obtained by photographing the subject by using the imaging unit 10. The preprocessor 12 may comprise a red-eye preprocessing feature to determine the possibility of red-eye. Or, a red-eye preprocessor having a red-eye preprocessing feature may be provided in the preprocessor 12. That is, photographing information may be acquired as well as data of a photographed image in the photography of a subject and red-eye preprocessing may be made to determine the possibility of red-eye by using the acquired photographing information in the red-eye preprocessor in the preprocessor 12. Then, automatic red-eye correction may be made by the automatic red-eye correcting section 18 only on a photographed image determined to possibly include red-eye.

The image memory 14 comprises a first folder 14a for storing digital image data of a subject obtained through photography, or image data (hereinafter referred to as original image data) which has undergone default image processing in the preprocessor 12 and a second folder 14b for storing corrected image data which has undergone automatic red-eye correction on red-eye in the image.

The automatic red-eye correcting section 18 comprises an automatic red-eye detecting subsection 20 for extracting a face region from the subject in the image to automatically detect red-eye and an automatic red-eye modifying subsection 22 for automatically modifying the detected red-eye. The red-eye preprocessing for determining the possibility of red-eye may be performed in the automatic red-eye correcting section 18 instead of the preprocessor 12. In other words, a red-eye preprocessor may be provided in the automatic red-eye correcting section 18 or the automatic red-eye detecting subsection 20 may have the red-eye preprocessing feature so that automatic red-eye detection in the automatic red-eye detecting subsection 20 can be performed only on a photographed image (data) determined to possibly include red-eye in the red-eye preprocessor or by the red-eye preprocessing feature.

The camera 1 also comprises an Exif tag recording unit 24 for recording predetermined information onto the Exif (Exchangeable Image File Format) tag in case original image data is Exif image data, a monitor 26 for displaying the data of a photographed original image or corrected image data, a card interface 30 for recording image data onto a memory card 28 as an image recording medium such as a SmartMedia, a camera controller 32 for performing camera control such as automatic exposure control and automatic focus control of the camera 1, and a CPU 34 for controlling each unit of the camera 1.

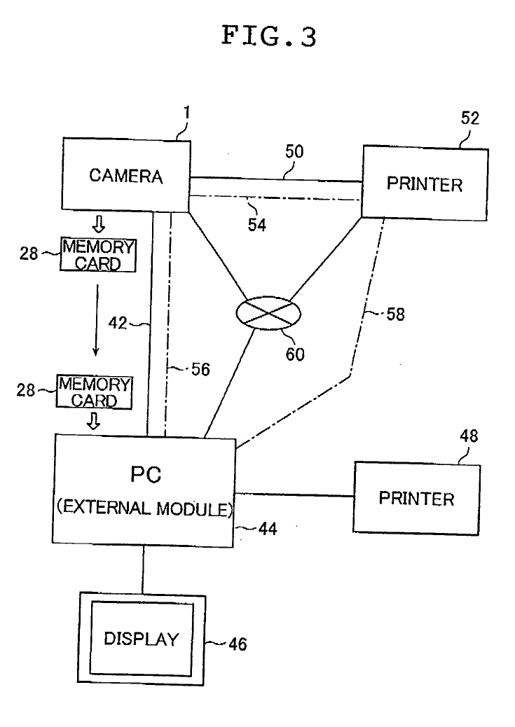

To the CPU 34 are connected an operation unit (selection means) 36 for selecting an image data storage mode mentioned later and providing other instructions to the camera 1, a communication unit 38 for performing communications between cameras or via a communication network such as the Internet to communicate image data and other information, and an externally connected terminal 40 for connecting to an external image processing module such as a personal computer (PC) (refer to a PC 44 in FIG. 3)

The image memory 14 stores image data. The image memory 14 according to this embodiment comprises, as mentioned earlier, at least two folders, the first folder 14a for storing original image data and the second folder 14b for storing corrected image data and correction information.

The original image data refers to data of a photographed image itself (unconverted image) obtained by photographing with the imaging unit 10 or image data which has undergone only default setup processing by the camera 1, as mentioned earlier. The corrected image data refers to image data which has undergone red-eye correction in the automatic red-eye correcting section 18 and optionally other image processing in the image processor 16.

The red-eye correction information refers to information necessary for red-eye correction related to the original image data, that is, a difference mask and information used to create a red-eye-corrected image. Particular details of red-eye correction information include, for example, information on the presence/absence of red-eye detection, information on the presence/absence of red-eye modification, information on the presence/absence of red-eye correction, information on the red-eye detection position (point) and detection area (which is collectively called position information), information on the detected red-eye count, information on the detected face position (point, area), red-eye correction mask information, and degree of red-eye modification.

In the following description, only corrected image data or corrected image data and red-eye correction information are referred to as red-eye correction data.

In order to store data, the base folder includes, for example, an original image folder (the first folder 14a in FIG. 1) for storing original image data and a red-eye-corrected image folder (the second folder 14b in FIG. 1) for storing corrected image data and red-eye correction information which is separate from the original image folder. Image data can be stored under the same file name in these folders in relation to each other. A red-eye correction information folder may be created in the corrected image folder so as to store red-eye correction information.

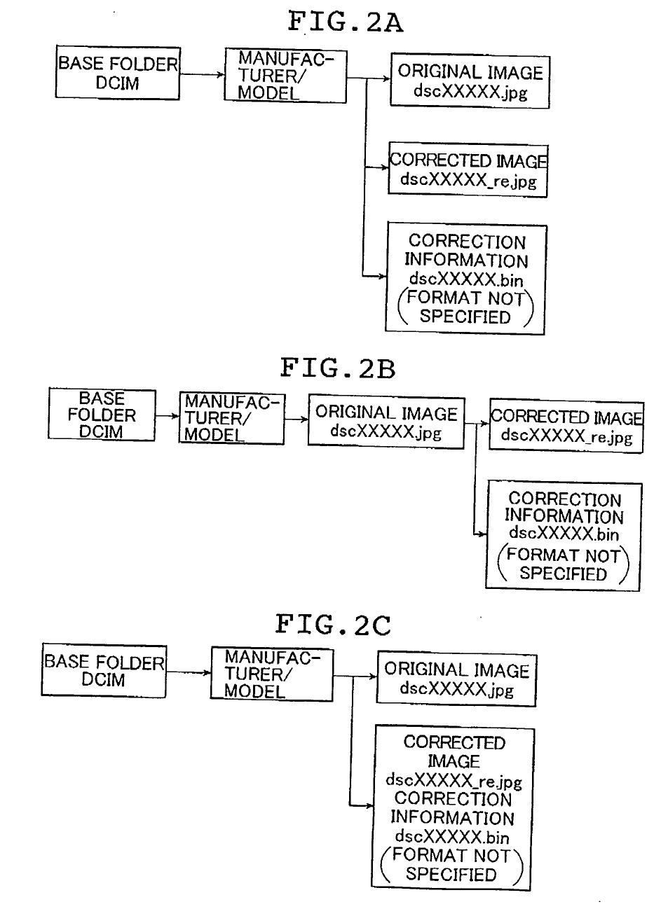

FIG. 2 shows an example of folder structure in the image memory 14. In the folder structure shown in FIG. 2A, a folder indicating a manufacturer/model is arranged under a base folder DCIM. Under the manufacturer/model folder are arranged a folder for storing original image data, a folder for storing corrected image data, and a folder for storing red-eye correction information.

The folder for storing original image data corresponds to the first folder 14a in FIG. 1 and the folder for storing corrected image data corresponds to the second folder 14b shown in FIG. 1. In this practice, the folder for storing red-eye correction information may be provided separately from the second folder 14b or in the second folder 14b.

The folder structure shown in FIG. 2B has more layers. A folder indicating a manufacturer/model is arranged under a base folder DCIM. Under the manufacturer/model folder is arranged a folder for storing original image data, under which are arranged a folder for storing corrected image data and a folder for storing red-eye correction information.

In the folder structure shown in FIG. 2C, a folder indicating a manufacturer/model is arranged under a base folder DCIM. Under the manufacturer/model folder are arranged a folder for storing original image data (corresponding to the first folder 14a in FIG. 1) and a folder for storing corrected image data and red-eye correction information (corresponding to the second folder 14b in FIG. 1).

Referring to FIG. 1 again, the automatic red-eye correcting section 18 automatically corrects red-eye in an image and comprises the automatic red-eye detecting subsection 20 for automatically detecting red-eye and the automatic red-eye modifying subsection 22 for automatically modifying the detected red-eye. Methods for detecting and modifying red-eye are not particularly limited but various known red detection methods and red-eye modification methods are applicable.

Methods for detecting red-eye include, for example, a method which includes extracting a face region of a subject in an image by using edge detection, shape pattern detection, or face detection through hue extraction or skin tone extraction, performing pupil extraction from the extracted face region using for example edge detection and shape pattern detection as well as position information and hue information, and detecting red-eye from the saturation and hue. The positions and count of red-eye are attached, as a result of red-eye detection, to an image for use in the subsequent red-eye modification.

Red-eye modification methods preferably include a method for modifying red-eye by color-converting the detected red-eye or lowering the saturation of the red-eye, and a method for correcting the saturation and lightness of all the other pixels so as to approach the minimum lightness of pixels in a detected red-eye region.

The Exif tag recording unit 24 records information such as presence/absence of red-eye correction, red-eye detection position and correction mask on original image data onto the Exif tag (private tag) in case the data is Exif image data.

The operation unit 36 is used by the user of the camera 1 to select a red-eye correction data storage method (storage mode) and instructs the method to the camera 1. In other words, the operation unit 36 is selection means for selecting a storage mode for red-eye correction data.

Red-eye correction data storage modes selectable by the operation unit 36 include Storage Mode A, Storage Mode B and Storage Mode C, which will be described below.

Storage Mode A performs automatic red-eye correction by way of digital image processing in the automatic red-eye correcting section 18 within the camera 1 and stores corrected image data which has undergone red-eye correction into a folder separate from one for original image data. Red-eye correction information related to original image data is also stored in the separate folder.

Storage Mode B does not create a corrected image U (data) but stores only red-eye correction information related to the original image data into a folder separate from one for the original image data.

Storage Mode C records red-eye correction information such as presence/absence of red-eye correction, red-eye detection position and correction mask onto an Exif tag in case the original image data is Exif image data. Thus, in this case also, as in Storage Mode B, corrected image data is not stored but the Exif tag recording red-eye correction information together with the original image data as Exif image data is stored.

The camera 1 of the above configuration is also used as an image output system while connected to an external device such as a PC and a printer. FIG. 3 schematically shows an image output system including the camera 1. The image output system shown in FIG. 3 comprises a PC 44 which is connected to the camera 1 (more specifically its externally connected terminal 40; see FIG. 1) via a serial bus 42, receives image data from the camera 1, performs image processing on the received image data and outputs the processed image data; a display 46 and a printer 48 connected to the PC 44; and a printer (for example a direct printer) 52 which is directly connected to the camera 1 (its external terminal 40) via a serial bus 50 and which performs direct printing.

The PC 44 comprises an image processing module for performing image processing including red-eye correction as an external module of the camera 1. The PC 44 displays processed image data on a display 16 and outputs the image data as a print from the printer 48.

The PC 44 comprises transmission/reception means capable of communicating various types of information including image data with other communication means such as a server via communication means such as the internet.

The PC 44 comprises a medium driver to which a memory card 28 storing image data can be attached by the camera 1, so as to input image data from the memory card 28. The PC 44, receiving original image data and red-eye correction information necessary for red-eye correction from the camera 1, can perform the same red-eye correction as that in the camera 1.

The printer 52 directly connected to the camera 1 via the serial bus 50 can directly output as a print a proper image free from red-eye after having been automatically red-eye-corrected in the camera 1.

The camera 1 (its communication unit 38; refer to FIG. 1) and the printer 52 (more specifically, its communication section (not shown)) may be connected via wireless communication means 54 such as infrared communication and wireless LAN instead of the serial bus 50. Corrected image data obtained by subjecting an image photographed with the camera 1 to automatic red-eye correction may be transmitted to the printer 52 via the wireless communication means 54 and a proper image free from red-eye may be directly output as a direct print from the printer 52. Instead of the serial bus 42, similar wireless communication means 56 may be used as connection means between the camera 1 and the PC 44. Wireless communication means 58 may be used to connect the PC 44 to the printer 52 and the image data processed in the PC 44 may be transmitted to the printer 52 by using wireless communication means and output as a print from the printer 52. The wireless communication means 54, 56 and 58 may be a single wireless communication network.

The camera 1, the PC 44 and the printer 52 may be interconnected via a communication network 60 such as the Internet instead of the serial buses 42, 50 or the wireless communication means 54, 56 and 58.

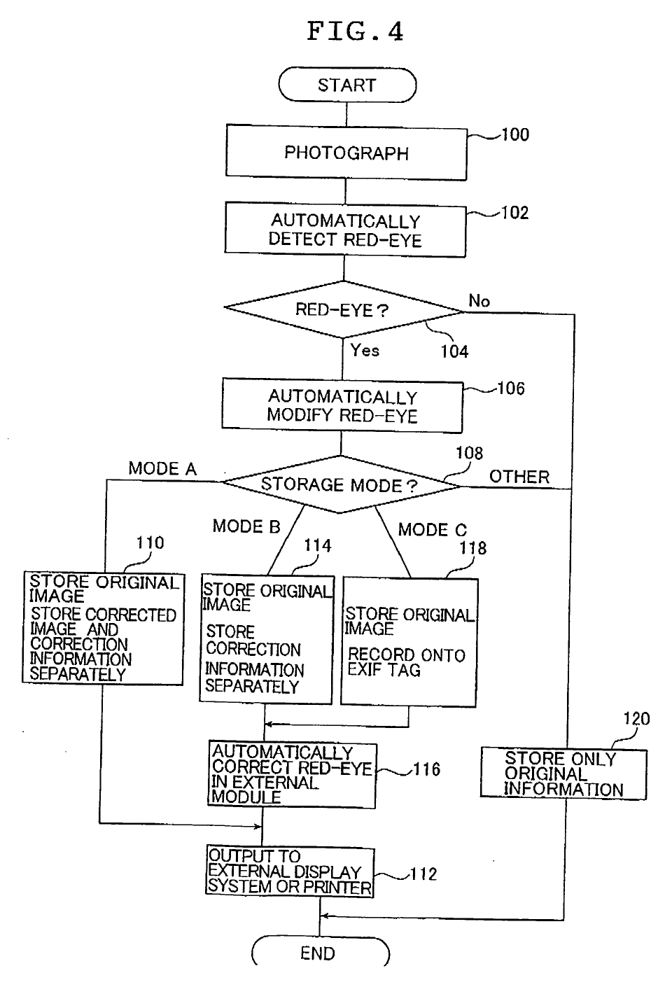

FIG. 4 is a flowchart showing the operation of this embodiment. The operation of this embodiment is described referring to this flowchart.

In step 100 of FIG. 4, a subject is photographed with the camera 1 to obtain the digital image data of the subject. The digital image data obtained by photographing is stored in the first folder 14a of the image memory 14 as original image data without performing further processing or after having performed default image processing in the preprocessor 12.

In step 102, the image processor 16 reads the original image data from the first folder 14a and performs automatic red-eye detection of the original image data in the automatic red-eye detecting subsection 20 of the automatic red-eye correcting section 18. A red-eye detection method may be a known method, as mentioned above.

In this practice, as mentioned earlier, it is preferable to determine the possibility of red-eye from photographing information such as presence of electronic flash in photographing an image, perform automatic red-eye detection only on an image which was determined to possibly include red-eye by the automatic red-eye detecting subsection 20, instead of providing a red-eye preprocessor in the preprocessor 12 or automatic red-eye correcting section 18, or incorporating a red-eye preprocessing feature in the preprocessor 12 or automatic red-eye detecting subsection 20 of the automatic red-eye correcting section 18 in order to perform automatic red-eye detection on all image data. In case absence of red-eye is clear from photographing information, such as in the absence of electronic flash or when the image is a landscape image without a person (especially the face of a person), absence of red-eye is preferably determined without further processing, while skipping red-eye detection by the automatic red-eye detecting subsection 20. By doing so, the total processing time of automatic red-eye correction on all photographed image data by the automatic red-eye correcting section 18 is reduced, which allows automatic red-eye correction to be efficiently performed on all photographed images.

Photographing information used for red-eye preprocessing includes, for example, electronic flash information, an Ev value, a shutter speed, an f number, a photographing mode, a camera model, lens information, a subject distance, a photographing duration, and a photographing time.

In step 104, the result of red-eye detection by the automatic red-eye detecting subsection 20 is checked. In case red-eye is not detected and it is determined that red-eye is absent, execution proceeds to step 120, where only original image data is stored into the first folder 14a to complete processing.

In case it is determined that red-eye is present in step 104, automatic red-eye modification is performed in the next step 106. Automatic red-eye modification is made by a known method mentioned earlier in which the automatic red-eye modifying subsection 22 receives detection information such as red-eye detection position from the automatic red-eye detecting subsection 20 to perform automatic red-eye modification.

Next, in step 108, the storage mode selected and specified previously or with a predetermined timing by the user on the operation unit 36 is determined through the camera 1. In accordance with the selected storage mode, the following processing is made.

For Storage Mode A, execution proceeds to step 110, where the original image data is stored into the first folder 14a and the corrected image data and red-eye correction information are stored into the second folder 14b. The corrected image data and the red-eye correction information related to the original image data by a file name and photographing date/time may be altogether stored into the second folder 14b. Alternatively, a separate folder may be provided in the second folder 14b so as to store corrected image data and red-eye correction information into separate folders respectively.

In case image data stored in Storage Mode A is to be output, the data is output to an external display system or a printer from the camera 1 in step 112. To be more precise, as shown in FIG. 3, the corrected image data is input to the external PC 44 from the camera 1 via the serial bus 42, the wireless communication means 56 such as infrared communication and wireless LAN or the internet 60, or from the memory card 28. The corrected image data thus input is converted to a data format conforming to an image output device and presented on the display 46 or output as a print of a red-eye-corrected, high-quality image from the printer 48. Alternatively, the corrected image data may be transmitted from the camera 1 to the printer 52 via the serial bus 50, the wireless communication means 54 or the Internet 60 and output as a direct print from the printer 52.

In Storage Mode B, in step 114, the original image data is stored into the first folder 14a and the red-eye correction information related to the original image data by a file name and photographing date/time is stored into the second folder 14b.

In case an image stored in Storage Mode B is to be output, execution proceeds to step 116, where automatic red-eye correction is made in the external automatic red-eye correction module. To be more precise, the original image data and red-eye correction information are input to the PC 44 via the serial bus 42, the wireless communication means 56 or the Internet 60, or from the memory card 28. The original image data then undergoes automatic red-eye correction by using red-eye correction information in the automatic red-eye correction module in the PC 44.

In case the printer 52 directly connected to the camera 1 via the serial bus 50, the wireless communication means 54 or the Internet 60 comprises an image processing chip having the automatic red-eye correction feature, the original image data and red-eye correction information are transmitted to the printer 52 and automatic red-eye correction may be performed in the image processing chip attached to the printer 52.

In step 112, the red-eye-corrected image is presented on the display 46 connected to the PC 44, output from the printer 48, or output as a direct print from the printer 52.

In Storage Mode C, execution proceeds to step 118, where information about presence/absence of red-eye correction, red-eye detection position and correction mask is recorded onto the Exif tag (private tag) for the original image data as the Exif image data while the original image data is stored into the first folder 14a.

In this case, when the image is to be output, execution proceeds to step 116, where automatic red-eye correction is made on the original image data in the external automatic red-eye correction module. To be more precise, the original image data is input to the PC 44 and automatic red-eye correction is made on the original image data in the automatic red-eye correction module in the PC 44 by using the red-eye correction information recorded on the Exif tag. Then, in step 112, the image is output from the display 46 or the printer 48 connected to the PC 44.

In case none of the foregoing modes are used, for example, in case red-eye correction is made but neither red-eye-corrected image data nor correction information is stored, execution proceeds to step 120, where only the original image data is stored into the first folder 14a.

While automatic red-eye correction is made immediately after image photographing in this embodiment for the convenience of description, the timing of automatic red-eye correction occurs basically during a period where other processing is not being performed, or the CPU 34 is idle. To be more precise, for example, when the camera 1 is turned off, automatic red-eye correction may be made before the power is completely shut down and the power may be turned off on completion of automatic red-eye correction.

Or, automatic red-eye correction may be performed while photographing is not in progress, for example, when the user is checking photographed images or in case the user has specified a particular image for automatic red-eye correction.

Automatic red-eye correction may be performed when the power is turned on except in the photographing mode.

As mentioned hereinabove, according to this embodiment, the original image data and the corrected image data (or correction information) are stored into separate folders. This approach has the following merits and advantages:

First, the original image data corresponds to a negative film for a camera using a conventional silver halide film and is naturally to be stored. Second, in case some abnormality in an image has taken place during automatic red-eye correction on the original image data, the original image data stored may be advantageously used to recover the original image data, even when the image processing is irreversible and corrected image is damaged.

Third, for the corrected image data to be readily available for direct printing where a camera is directly connected to a printer to perform printing or printing on a terminal in a photo processing shop, the corrected image data needs to be stored separately from the original image data. By storing the corrected image data separately from the original image data, it is possible to support connection to a device not equipped with an external automatic red-eye correction feature or a device whose processing time is limited.

The correction information has data compatibility with the external automatic red-eye feature in order to simplify the external automatic red-eye correction and shorten the processing time. Storing an image corrected by the camera allows complete matching between a print with film processing and a reprint (extra print).

Another advantage is support for upgrade of performance of an external automatic red-eye correction module by applying the original image data and correction information.

While the corrected image data which has undergone automatic red-eye correction is stored separately from the original data in the embodiments mentioned above, correction results other than the results of automatic red-eye correction, for example, gradation correction, density correction, color correction, correction of deterioration of marginal luminosity, and correction of distortion and lateral chromatic aberration may be stored, in case an image processing chip to perform various types of image processing is mounted on the camera.

While the camera equipped with the red-eye correction feature according to the invention has been detailed, the invention is not limited to the various embodiments but may be modified or changed without departing the scope and spirit thereof.

1. A camera equipped with a red-eye correction feature, said camera comprising:
imaging means for photographing a subject to acquire digital image data;
a first folder for storing original image data which has undergone no image processing or default image processing alone on said digital image data;
automatic red-eye correction means for performing an automatic red-eye correction on said original image data by detecting automatically red-eye on a photographed subject image in said original image data and modifying automatically the thus detected red-eye to obtain corrected digital image data which has undergone said automatic red-eye correction; and
a second folder for storing at least one of said corrected digital image data and red-eye correction information related to said original image data and used to perform said automatic red-eye correction, said second folder being separate from said first folder.

2. The camera equipped with the red-eye correction feature according to claim 1, further comprising:
selection means for selecting whether said second folder stores said corrected digital image data and said red-eye correction information, or said red-eye correction information alone.

3. The camera equipped with the red-eye correction feature according to claim 1, wherein said original image data is Exif image data, and said selection means selects whether said second folder stores said corrected digital image data and said red-eye correction information, or said red-eye correction information alone, and alternatively, whether said red-eye correction information including at least presence or absence of said red-eye correction is recorded in an Exif tag.

4. The camera equipped with the red-eye correction feature according to claim 1, wherein said red-eye correction information includes at least one of presence or absence of said red-eye correction, a difference mask between said corrected digital image data and said original image data, and information used to create a red-eye-corrected image.

5. The camera equipped with the red-eye correction feature according to claim 1, wherein said red-eye correction information includes at least one selected from the group consisting of information on presence or absence of red-eye detection, information on presence or absence of red-eye modification, information on presence or absence of said red-eye correction, information on a red-eye detection position, information on a red-eye detection area, red-eye position information, information on detected red-eye count, information on a detected face position, information on a detected face area, information on face position, red-eye correction mask information, and degree of red-eye modification.
